(19) United States
(12) Patent Application Publication
(10) Pub. No.: US 2009/0242151 A1
(43) Pub. Date: Oct. 1, 2009

(54) WHOLE-COVERED SUNSHADE ASSEMBLY

(76) Inventor: Anderson Chen, Taipei Hsien (TW)

Correspondence Address: Anderson Chen, 235 Chung - Ho, Box 8-24, Taipei, 235, TW

(21) Appl. No.: 12/054,387

(22) Filed: Mar. 25, 2008

(51) Int. Cl. B60J 11/02

(52) U.S. Cl. 160/370.22

(57) ABSTRACT

A whole-covered sunshade assembly comprises a sunshade plate having an approximate oblong shape; a bottom of the sunshade plate extended with a plurality of retaining sets and a plurality of support seats; each retaining seat having a through hole; each support seat having an penetrating hole; four sunshade curtains; each sunshade curtain being retained to a retaining shaft and can be wound around the retaining shaft; the retaining shaft being retained to the through hole of the retaining seat; at least one support shaft retained to the penetrating holes of the support seat; and a plurality of retaining clamp plates. The retaining shafts are placed into the through holes of the retaining seats; the support shafts are placed into the penetrating holes of the support seats to be fixed therein.

### FIELD OF THE INVENTION

The present invention relates to sunshades of a car, in particular to a whole-covered sunshade assembly, wherein the sunshade assembly has four sunshade curtains which can cover the four sides of a car so as to shield the sunshine from all sides and retain the interior of car without sunshine. An upper side of the sunshade assembly has a frame for receiving objects.

### BACKGROUND OF THE INVENTION

In the prior art sunshade assembly, U.S. Pat. No. 7,188,886, a sunshield assembly for use in automotive vehicles prevents potentially damaging solar radiation from entering the interior of the vehicle through a windshield when in motion or parking of the vehicle. The sunshield assembly comprises a mount which is fixedly installed on a windshield of the automotive vehicle, a deployable and retractable sliding unit including a plurality of connector members having the same configuration and adapted to be successively coupled to one another, and a cover configured to be coupled to an outermost one of the connector members, wing members each having a triangular steel liner narrowing toward an outer end thereof, and a coating layer attached to one surface of the steel liner, the coating layer consisting of a paper sheet, and a transparent film bonded to each other, and a holder for fixing the cover.

In another prior art, U.S. Pat. No. 5,937,929, a car curtain for covering a car window is disclosed which comprises: a main body, mounted on the window frame by several fixing devices, allowing the car curtain to be installed at any desired angle within the car window; a pleated curtain, having a rear edge, which is mounted on the main body, and a front edge, which is movable against the rear edge for unfolding or folding the pleated curtain; and a guiding system, which is mounted on the main body and from which a guider extends with a variable length, the guider running along the outer side of the pleated curtain or through holes in the pleated curtain near the upper edge thereof and consisting of at least one thread with a rear end, connected to the guiding system, and a front end, attachable to a fixing element at a fixed position on the car window; wherein the guider prevents the pleated curtain from swaying and keeps the pleated curtain close to the car window.

However, in the prior art, the sunshade is mainly used at the front wind shield glass, while the sunshine is still incident from other sides of the car. Thus the prior arts are not practical and a more novel design is necessary to improve the defects in the prior arts.

### SUMMARY OF THE INVENTION

Accordingly, the object of the present invention is to provide a whole-covered sunshade assembly, wherein the sunshade assembly has four sunshade curtains which can cover the four sides of a car so as to shield the sunshine from all sides and retain the interior of car without sunshine. An upper side of the sunshade assembly has a frame for receiving objects.

To achieve above object, the present invention provides a whole-covered sunshade assembly comprising a sunshade plate having an approximate oblong shape; a bottom of the sunshade plate extended with a plurality of retaining sets and a plurality of support seats; each retaining seat having a through hole; each support seat having an penetrating hole; four sunshade curtains; each sunshade curtain being retained to a retaining shaft and can be wound around the retaining shaft; the retaining shaft being retained to the through hole of the retaining seat; at least one support shaft retained to the penetrating holes of the support seat; a plurality of retaining clamp plates. The retaining shafts are placed into the through holes of the retaining seats; the support shafts are placed into the penetrating holes of the support seats to be fixed therein.

The various objects and advantages of the present invention will be more readily understood from the following detailed description when read in conjunction with the appended drawing.

### BRIEF DESCRIPTION OF THE DRAWINGS

FIG. 1(A) is a schematic view about the sunshade plate of the present invention.

FIG. 1(B) is a schematic view about the sunshade curtain of the present invention.

FIG. 1(C) is a schematic view about the retaining shaft and the retaining clamp plate of the present invention.

FIGS. 2(A) to 2(D) show the various forms of the combining sections in the sunshade curtain of the present invention.

FIG. 3(A) shows the arrangement of the motor and the circuit in the retaining shaft of the present invention.

FIG. 3(B) shows the arrangement of the motor, battery set, circuit in the retaining shaft of the present invention.

FIG. 4 shows application of the present invention.

FIGS. 5A and 5B are assembly views of the present invention.

### BRIEF DESCRIPTION OF THE DRAWINGS

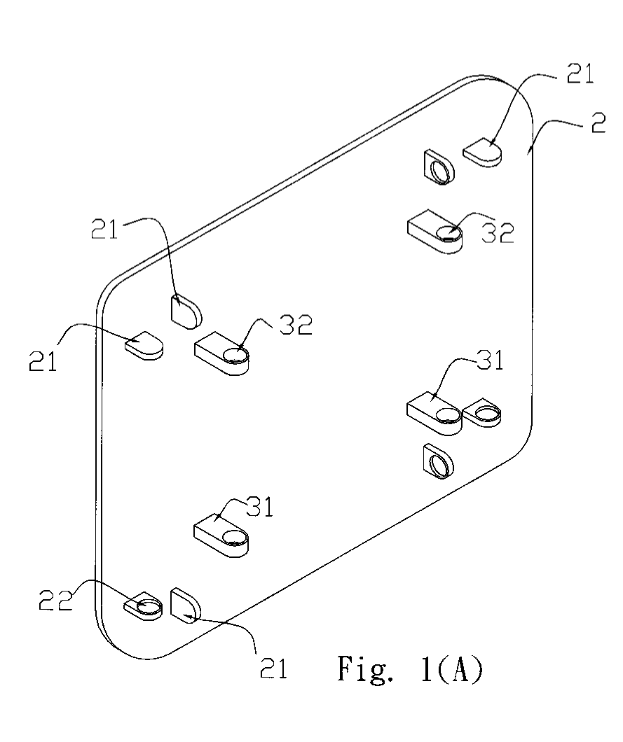

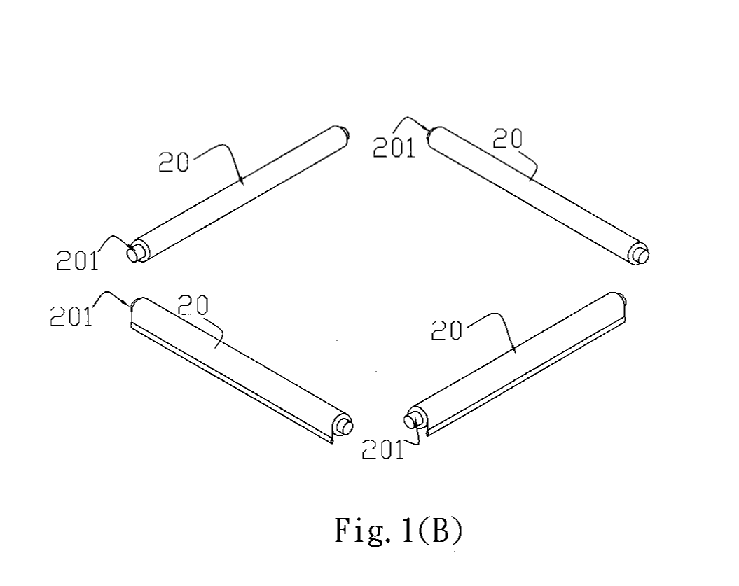

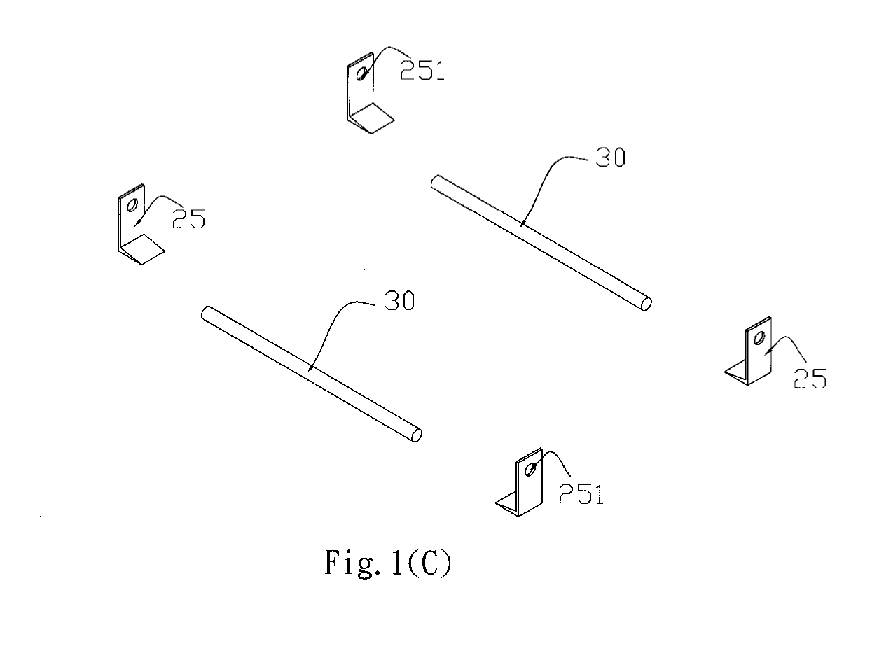

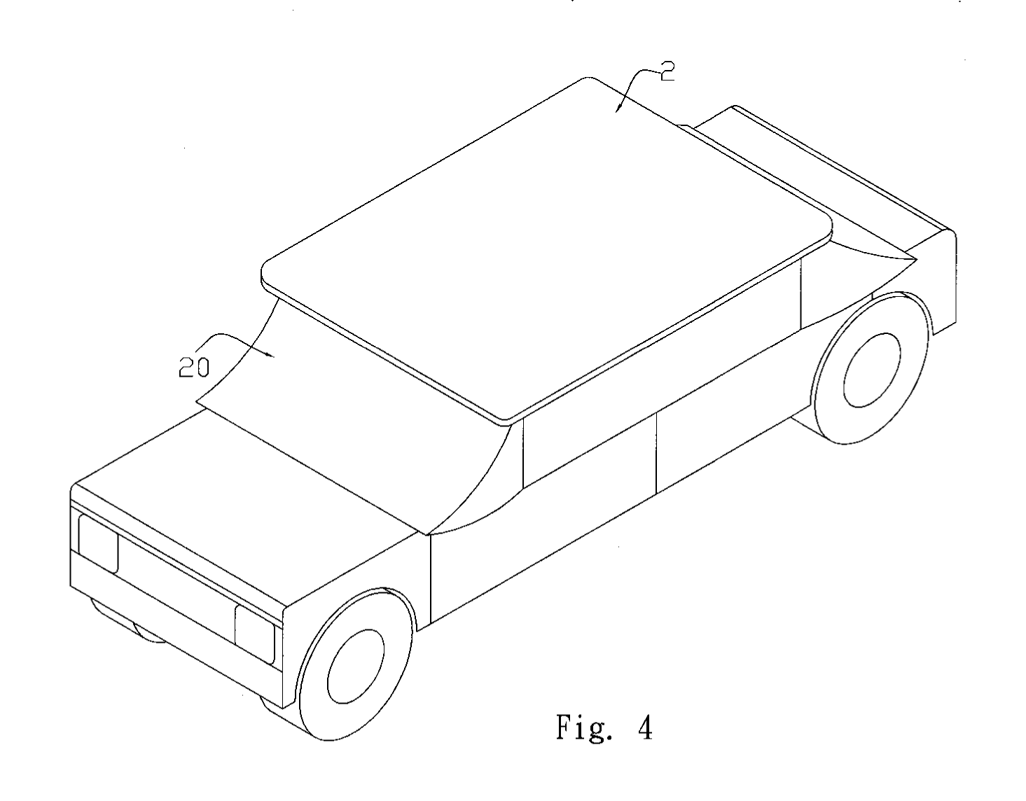

Referring to FIGS. 1 to 4, a whole covered vehicle shade of the present invention is illustrated. The present invention includes the following elements.

A sunshade plate 2 has an approximate oblong shape. A top of the sunshade plate 2 has a frame 200 for supporting objects. The frame 200 has an approximate rectangular shape and is connected to the sunshade plate 2. An upper portion of the frame 200 is formed with a space for receiving objects.

A bottom of the sunshade plate 2 is extended with a plurality of retaining seats 21 and a plurality of support seats 31. Each retaining seat 21 has a through hole 22. Each support seat 31 has a penetrating hole 32 (as shown in FIG. 1A).

Four sunshade curtains 20 are included. Each sunshade curtain 20 is retained to a retaining shaft 201 and can be wound around the retaining shaft 201. The retaining shaft 201 is retained to the through hole 22 of the retaining seat 21 (as shown in FIG. 1B).

At least one support shaft 30 is retained to the penetrating holes 32 of the support seat 31 (see FIG. 1C).

A plurality of retaining clamp plates 25 is included. Each retaining clamp plate 25 has an L shape. One side of the retaining clamp plate 25 has an opening 251. The retaining clamp plates 25 are retained at outer sides of the support seat 31 for retaining the support shaft 30 at two sides thereof (as shown in FIG. 1C).

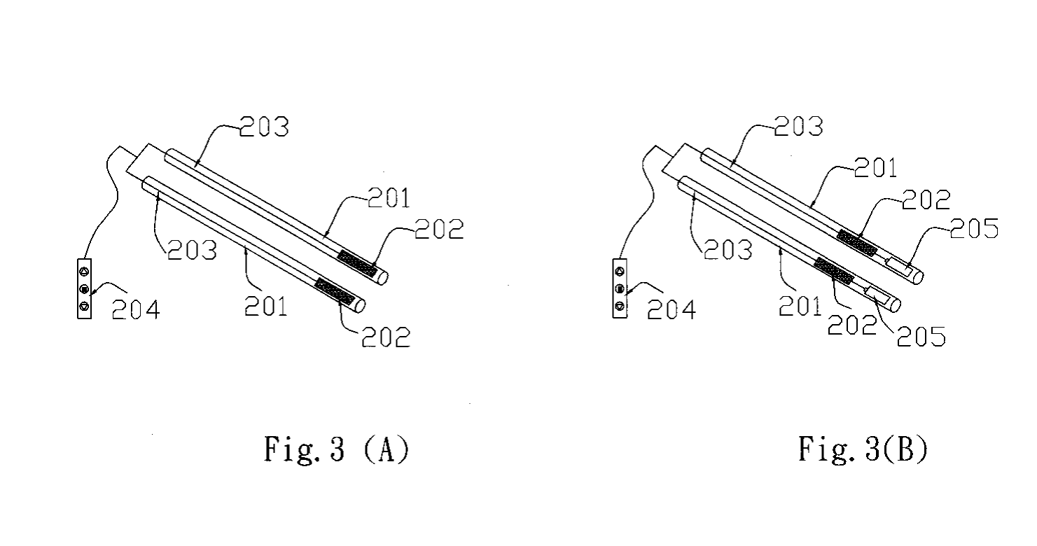

Referring to FIG. 3A, it is illustrated that an interior of the retaining shaft 201 has a motor 202 and a control circuit 203. The motor 202 is connected to the control circuit 203. The control circuit 203 is connected to a controller 204. The controller 204 serves to control the operation of the motor 202 so as to further drive the retaining shafts 201 to rotate. Thus the sunshade curtain 20 can be pulled downwards for shading sunlight and upwards. The controller 204 can be installed inside the car.

Referring to FIG. 313, it is illustrated that a battery set 205 can be added to the retaining shaft 201 for supplying power to drive the motor 202 and thus to drive the retaining shaft 201.

In the present invention, the signal transmission between the controller 204 and motor 202 may be wired or wireless. The controller 204 may be a remote controller.

The control circuit 203 can be combined the control panel of the car. The power is from the car for driving the motor 202 to rotate.

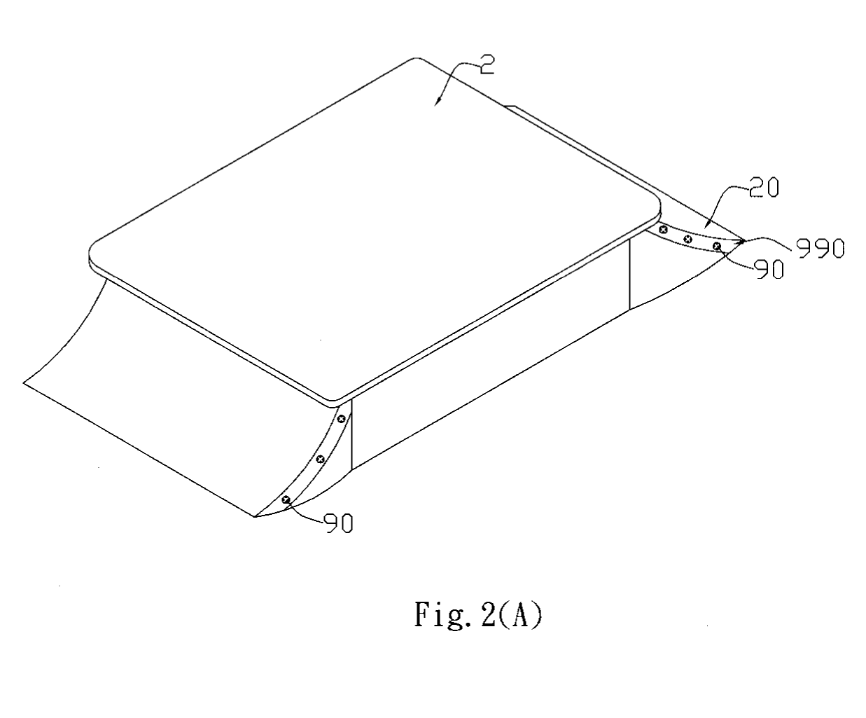

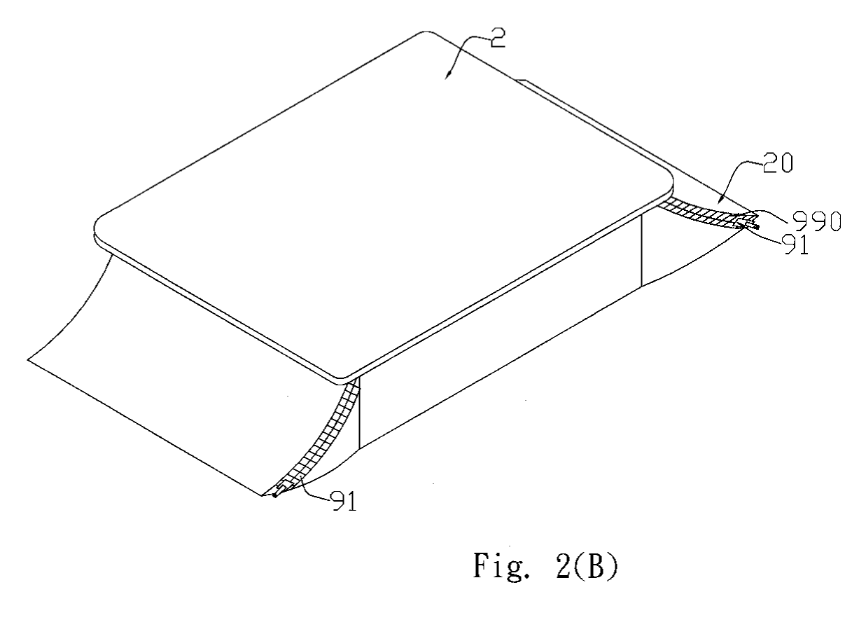

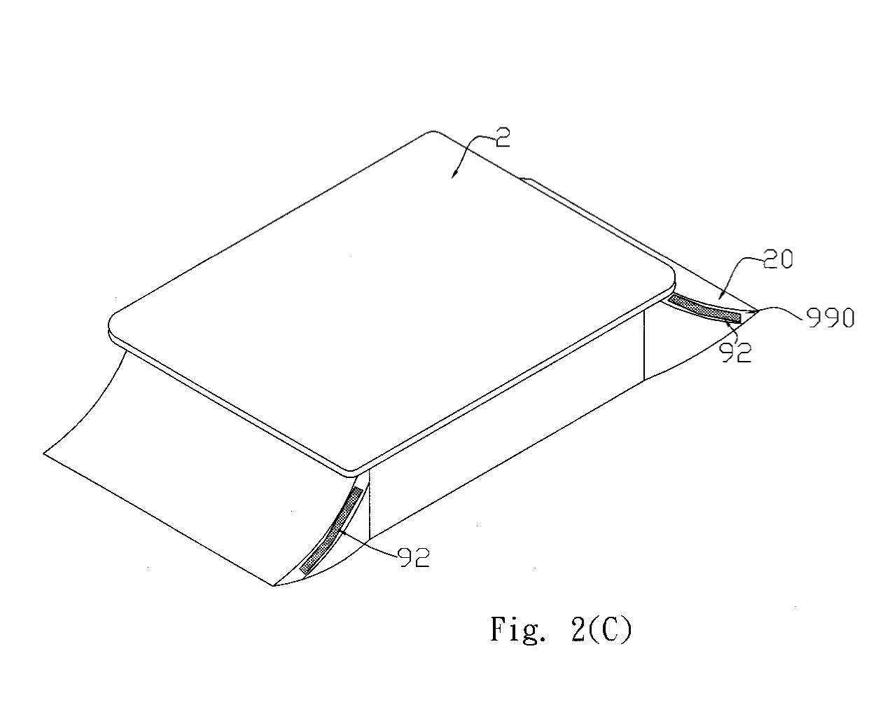

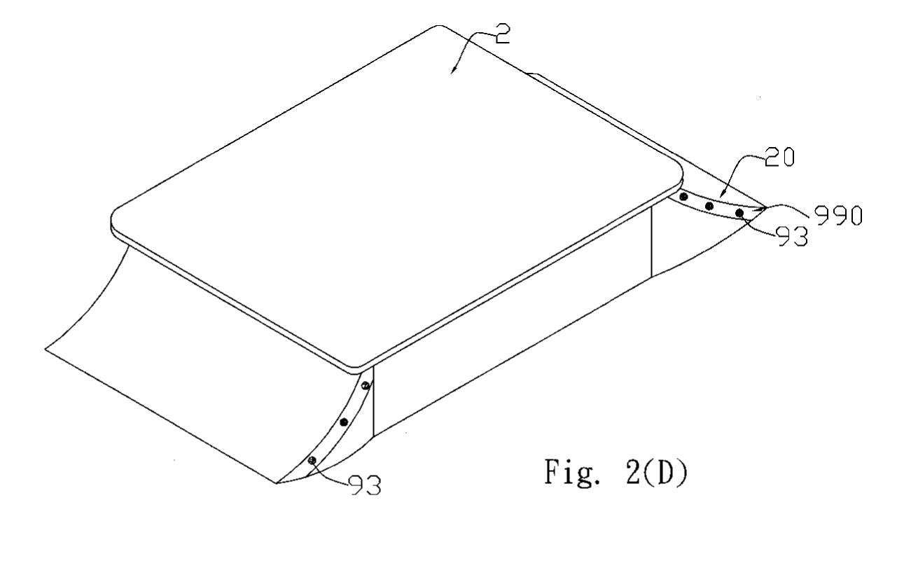

Referring to FIGS. 2A to 2D, it is illustrated that in the present invention, each sunshade curtain 20 has a combining section 990 which serves to combine with another sunshade curtain 20. In the present invention, the combining section 990 may be the combination of buttons 90, or zippers 91, or Velcro fastener 92 or magnets 93. However other ways are permissible in the present invention.

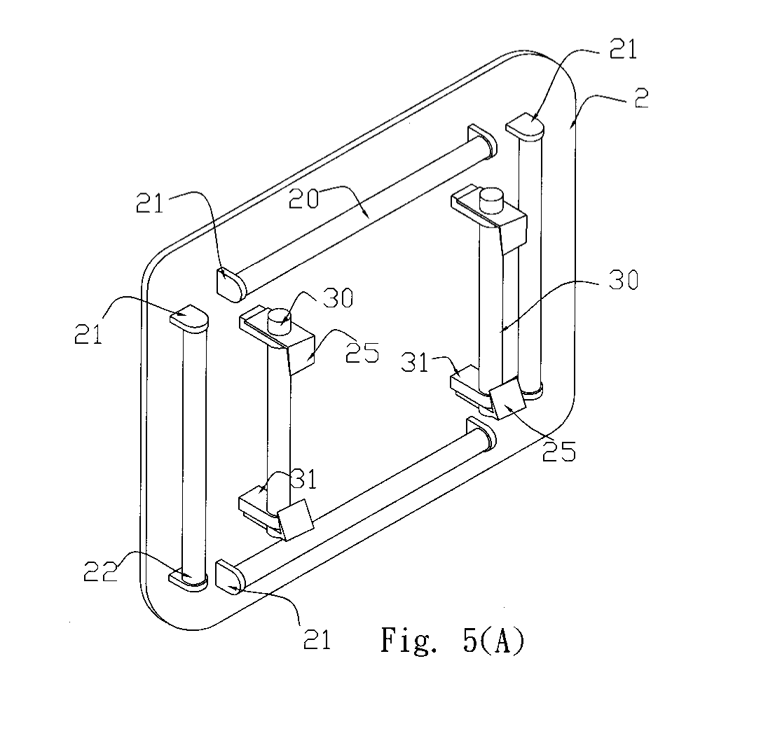

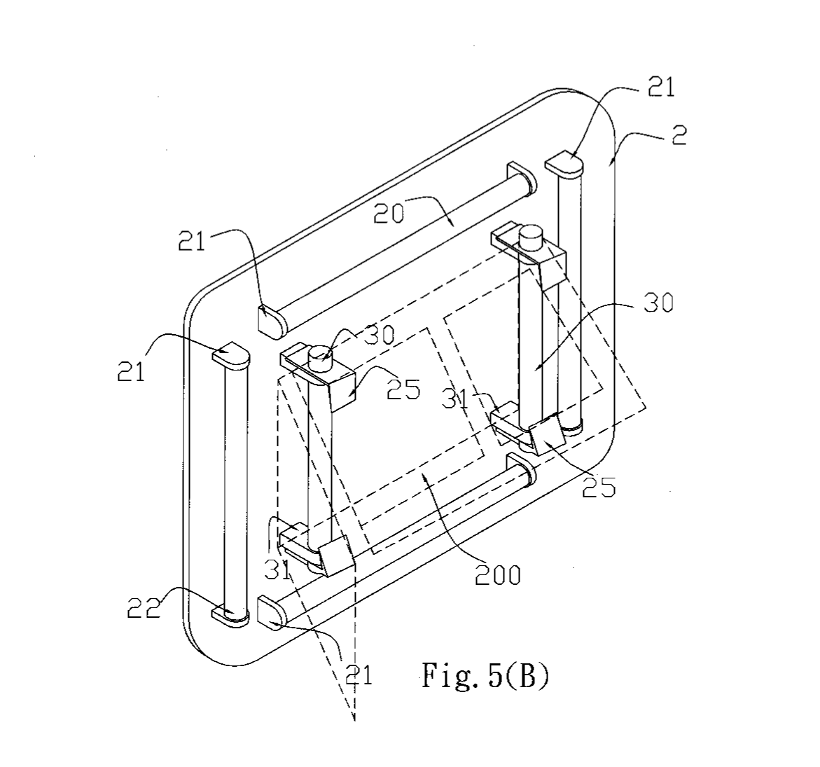

In assembly of the present invention, as illustrated in FIGS. 5A and 5B, the retaining shafts 201 are placed into the through holes 22 of the retaining seat 21. The support shafts 30 are placed into the penetrating holes 32 of the support seats 31 to be fixed therein. Then the retaining clamp plates 25 are placed at an outer side of the support seats 31. Each retaining clamp plate 25 has an L shape. A side of the L shape has no opening is fixed to the car near the window (see FIG. 5B) so as to tightly engage the shade of the present invention to the car.

In the present invention, the user can operate the controller 204 to make the sunshade curtains 20 to extend downwards so as to shield the window from sunshine. The sunshade curtains 20 can be connected one by one. The sunshade curtains 20 can be lifted upwards by the controller. The receiving space at the upper side serves to place objects therein.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A whole-covered sunshade assembly, comprising;
a sunshade plate having an approximate oblong shape;
a bottom of the sunshade plate extended with a plurality of retaining sets and a plurality of support seats; each retaining seat having a through hole; each support seat having an penetrating hole;
four sunshade curtains; each sunshade curtain being retained to a retaining shaft and can be wound around the retaining shaft; the retaining shaft being retained to the through hole of the retaining seat;
at least one support shaft retained to the penetrating holes of the support seat;
a plurality of retaining clamp plates; and
wherein the retaining shafts are placed into the through holes of the retaining seats; the support shafts are placed into the penetrating holes of the support seats to be fixed therein.

2. The whole-covered sunshade assembly as claimed in claim 1, further comprising a plurality of retaining clamp plates are retained to the support seats for retaining the sunshade plate to a car.

3. The whole-covered sunshade assembly as claimed in claim 3, wherein each retaining clamp plate has an L shape; one side of the retaining clamp plate has an opening; and another side of the L shape has no opening and is fixed to the car near the window so as to tightly engage the shade of the present invention to the car.

4. The whole-covered sunshade assembly as claimed in claim 2, wherein a top of the sunshade plate has a frame for supporting objects; the frame has an approximate rectangular shape and is connected to the sunshade plate; and an upper portion of the frame is formed with a space for receiving objects.

5. The whole-covered sunshade assembly as claimed in claim 2, wherein an interior of the retaining shaft has a motor and a control circuit; the motor is connected to the control circuit; and the control circuit is connected to a controller; the controller serves to control the operation of the motor so as to further drive the retaining shafts to rotate; and thus the sunshade curtain can be pulled downwards for shading sunlight and upwards.

6. The whole-covered sunshade assembly as claimed in claim 5, wherein the controller is installed inside a car.

7. The whole-covered sunshade assembly as claimed in claim 7, wherein a battery set is added to the retaining shaft for supplying power to drive the motor.

8. The whole-covered sunshade assembly as claimed in claim 7, wherein signal transmission between the controller and motor is wired or wireless.

9. The whole-covered sunshade assembly as claimed in claim 6, wherein the control circuit is combined a control panel of a car and the power is from the car for driving the motor to rotate.

10. The whole-covered sunshade assembly as claimed in claim 2, wherein each sunshade curtain has two combining sections at two lateral sides thereof; and the combining section serves to combine with another sunshade curtain.

11. The whole-covered sunshade assembly as claimed in claim 10, wherein the combining section has buttons and button holes.

12. The whole-covered sunshade assembly as claimed in claim 1, wherein the combining section has zippers.

13. The whole-covered sunshade assembly as claimed in claim 1, wherein the combining section has Velcro fasteners.

14. The whole-covered sunshade assembly as claimed in claim 1, wherein the combining section has magnet.
